(19) United States
(12) Patent Application Publication
(10) Pub. No.: US 2025/0329524 A1
(43) Pub. Date: Oct. 23, 2025

(54) ION GUIDING SYSTEM

(71) Applicant: Thermo Fisher Scientific (Bremen) GmbH, Bremen (DE)

(72) Inventors: Hamish Stewart, Bremen (DE); Alexander A. Makarov, Bremen (DE)

(73) Assignee: Thermo Fisher Scientific (Bremen) GmbH, Bremen (DE)

(21) Appl. No.: 19/175,387

(22) Filed: Apr. 10, 2025

(30) Foreign Application Priority Data
Apr. 18, 2024 (GB) 2405445.4

(51) Int. Cl. H01J 49/42; G01N 27/623

(52) U.S. Cl. CPC H01J 49/4225; G01N 27/623; H01J 49/4235

(57) ABSTRACT

An ion guiding system comprises a multipole ion guide having a plurality of multipole electrodes configured to provide a first confinement field. The ion guiding system also comprises an RF confinement device configured to provide a second confinement field, wherein the RF confinement device comprises a radio frequency (RF) surface having a plurality of RF electrodes. The ion guiding system also comprises an interface located in a transition region between the multipole ion guide and the RF surface, wherein the interface has a plurality of interface electrodes configured to provide an interface field that transitions between the first confinement field and the second confinement field. There is also provided a beam switching device for an analytical instrument comprising the ion guiding system; a mass spectrometer comprising the ion guiding system; and an ion mobility spectrometer comprising the ion guiding system.

### CROSS REFERENCE TO RELATED APPLICATION

This application claims priority from application GB2405445.4, filed Apr. 18, 2024. The entire disclosure of application GB2405445.4 is incorporated herein by reference.

### FIELD OF THE INVENTION

The present disclosure relates an ion guiding system. In particular the present disclosure relates to an ion guiding system for transmitting ions between a multipole ion guide and a radio frequency surface. The present disclosure also relates to a beam switching device and a mass spectrometer comprising an ion guiding system.

### BACKGROUND

Radio frequency (RF) ion guides, for example multipoles, are integrated into modern mass spectrometers and other instruments (including ion mobility spectrometers) and serve a variety of roles. Ion funnels capture and focus ion beams. Multipoles of different orders shuttle ions, or constrain them radially during trapping, ejection or fragmentation processes.

RF surfaces are commonly used to form ion guides and are created from an alternating series of opposing polarity electrodes, which creates an RF field that falls off abruptly with distance from the electrodes. Ions may approach close to the electrodes but then feel a sharp repulsion. A pure form of RF surface guide is termed an RF carpet.

At the termination of RF ion optics, or at interfaces between different devices, such as an RF surface and a multipole, fringe field effects may occur. At such interfaces, pseudopotential barriers are formed that may stop or reflect ions or excite ions that manage to make it through.

In known devices, to reduce the pseudopotential barriers and avoid the issues described above, at interfaces between RF ion guides, the fringe field is terminated by an aperture with an applied DC. The aperture normally has a smaller radius than the radius of the ion guide, to eliminate axial RF, but is large enough for efficient ion transmission. This arrangement addresses the problems associated with the fringe field effects. However, a proportion of the ion path loses RF focusing, and to maintain transmission ions are normally given several eV to cross. Apertures are also weak spots for build-up of contamination that may require regular cleaning and have limitations on gas conductance restriction due to their need to be sufficiently open and thin.

Therefore, it would be preferable to not have apertures in such devices, to avoid loss of RF focusing. It would be preferred to have a continuous RF channel.

GB2613439 has a quadrupole with phase locked RF between two segments, so that ions may cross the interface seamlessly even whilst radically different ion m/z may be processed in each region. A gas conductance restriction at the interface allows a substantial pressure variation between the two segments. However, this style of interface only works when the trapping field on each side is of a similar size and shape. Therefore, an RF barrier will still form if the trapping field is not equal size or shape.

Existing arrangements aim to combine two different devices without forming a pseudopotential barrier, using a range of techniques.

U.S. Pat. No. 9,123,517B2 demonstrates a segmented multipole, such as a dodecapole, where application of different RF potentials to the multipole segments allows a shift in the multipolar order as ions progress down the channel.

Known ion funnels (U.S. Pat. No. 6,107,628A, and Kelly, Tolmachev et al, Mass Spectrom. Rev., 2010, 29(2), 294-312) spread the field transmission over a wide region to minimise disruption, whereby a wide radius stacked ring ion guide slowly transitions to a narrow radius, providing gradual spatial focusing without imposing a cliff-edge RF barrier. Similarly, quadrupoles and hexapoles with a varying radius are known (for instance, U.S. Pat. No. 8,193,489B2).

Ion injection becomes high energy, and ion extraction very difficult from a large open area system without an additional expensive ion funnel structure. Multiple DC apertures, as would normally be required in a beam switching device, also bleed a large amount of gas into the surrounding vacuum system, to the detriment of neighbouring devices such as ion guides, mass analysers and quadrupole mass filters. Improved approaches for forming ion guides are therefore desirable.

### SUMMARY

In accordance with a first aspect, there is provided an ion guiding system, comprising:
a multipole ion guide having a plurality of multipole electrodes configured to provide a first confinement field;
an RF confinement device configured to provide a second confinement field, wherein the RF confinement device comprises a radio frequency (RF) surface having a plurality of RF electrodes; and
an interface located in a transition region between the multipole ion guide and the RF surface, wherein the interface has a plurality of interface electrodes configured to provide an interface field that transitions between the first confinement field and the second confinement field.

It has been appreciated by the present inventors that a smooth apertureless injection and extraction would be very advantageous. The ion guiding system according to the present disclosure comprises an interface which enables a multipole ion guide and RF surface to be interfaced. The interface of the present disclosure provides a transition between a first confinement field of the multipole, and a second confinement field of an RF surface, such that fringe field effects are reduced compared to simply combining the multipole ion guide and RF surface without an interface. The ion guiding system therefore provides an improved ion guide which reduces fringe field effects without requiring an aperture. The interface may be mounted on the same substrate as the RF surface. This has the advantage that it provides a simple approach to providing an interface. Furthermore, an RF surface has a high degree of flexibility in its construction and the most space. Therefore, it is advantageous to incorporate the interface onto the same substrate as the RF surface, instead of having the interface as a separate apparatus.

The plurality of RF electrodes may be formed along a substantially planar surface. The planar surface may extend along first and second axes (e.g. x and z axes), which may be perpendicular to one another.

The RF surface may be an RF carpet.

The RF confinement device may comprise a plate opposing the first RF surface, wherein a voltage is applied to the plate such that the ions are repelled towards the RF surface. As such, the second confinement field may be provided by a combination of the RF surface and the plate. Alternatively, the RF confinement device further comprises a second RF surface, e.g. such that the second confinement field is provided by a combination of the RF surface and the second RF surface. The second surface may be opposite the first surface, i.e. may face the first surface in a direction along a third axis (e.g. the y axis) which is perpendicular to each of the first and second axes (e.g. x and z axes). The second surface (together with the first surface) may be configured to confine the ions approximately to a plane between the first and second surfaces (i.e. as the ion travels travel though the confinement device). Ions will in general undergo oscillatory motion as they travel though the confinement device, with their average positions being approximately described by the plane between the first and second surfaces.

The distance, along the y axis, between the plurality of RF electrodes and the plane around which the ions are confined as they travel through the ion guiding system may be greater than the distance, along the y axis, between the plurality of multipole electrodes and the plane around which the ions are confined as they travel through the ion guiding system. This is advantageous as it has been realised that by providing a different separation distance between RF electrodes and the plane as between the multipole electrodes and the plane, it is possible to reduce RF penetration in the RF confinement device to the plane around which the ions are confined, compared to the multipole. By reducing the RF penetration to the plane in which ions are confined in the RF confinement device, the ion beam divergence is reduced within the RF surface. Optionally the interface electrodes are shaped such that the distance, along the y axis, between the surface of one or more or each interface electrode and the plane around which the ions are confined decreases along the transition region, i.e. the distance in the y direction increases with an increase in distance in the z direction from the multipole. This distance along the y axis may be greater closer to the RF confinement device, and smaller closer to the multipole. This distance may decrease in a step-wise manner, but more beneficially may decrease continuously across most or all of the length (in the z direction) of the interface. This is advantageous as the decrease in distance provides the transition region such that the confinement field is transitioned from the multipole to the RF surface. Such a transition in separation between electrodes and the plane around which the ions are confined reduces the generation of pseudopotential barriers, compared to having no transition region.

Optionally, the multipole may be offset from the RF surface in the y direction. The interface region may provide a gradual change in the offset, such that the offset between the interface electrodes and the RF surface electrodes, in the y direction, decreases with distance towards the RF surface in the z direction.

Further optionally, one or more or each of the interface electrodes may be wedge shaped such that the interface electrodes extend along the y axis. In other words, the electrodes may be shaped such that the interface electrodes extend perpendicular to the plane in which the ions travel. The interface electrodes may have a depth which increases or decreases in a step-wise manner, wherein the depth extends in the y direction. Each of the interface electrodes may have a surface which is oblique to the y direction and the z direction, such that the distance between the surface of the interface electrode and the plane around which the ions are confined decreases in a smooth manner. The interface electrodes may be wedge-shaped wherein the wedge-shaped electrode is orientated such that the distance decreases in a smooth manner. Alternatively, the interface electrodes may be flat (e.g. strip) electrodes arranged at an angle such that the distance, in the y direction, between the surface of the interface electrode and the plane around which the ions are confined decreases in a smooth manner. This is advantageous as wedge shaped electrodes provide a smooth transition between the multipole and RF surface.

A number of RF electrodes per unit length along an x axis may be less than a number of multipole electrodes per unit length along the x axis. For example, the spacing between the centre of each of the plurality of RF electrodes in the x direction may be less than the spacing between the centre of each of the plurality of multipole electrodes in the x direction. This is advantageous as it has been realised that by providing a greater number of RF electrodes per unit length, it is possible to reduce RF penetration in the RF confinement device to the plane around which the ions are confined, compared to the multipole.

The width of each of the plurality of RF electrodes in the x direction may be less than the width of each of the plurality of multipole electrodes in the x direction. This is advantageous as it has been realised that by providing a greater number of RF electrodes, it is possible to reduce RF penetration in the RF confinement device to the plane around which the ions are confined, compared to the multipole. The number of RF electrodes may be increased by providing RF electrodes in the RF surface which have a smaller width compared to the width of the multipole electrodes.

Optionally, one or more or each of the plurality of interface electrodes has a width, along an x axis, at a first end of the interface which is different to a width of the interface electrode at the second end of the interface. Optionally, the width, along the x axis, of each of the plurality of interface electrodes at one end of the interface may be smaller than the width of each interface electrode at the other end of the interface. Therefore, the interface electrodes provide a transition between the different widths of electrodes. This is advantageous as the change in width provides a transition region in which the confinement field is transitioned from the multipole to the RF surface. Such a transition in width of electrodes reduces the generation of pseudopotential barriers, compared to having no transition region.

A number of interface electrodes per unit length along an x axis at a first end of the interface may be different to a number of interface electrodes per unit length along the x axis at a second end of the interface. Optionally, there may be a greater number of interface electrodes at a first end of the interface compared to the number of interface electrodes at a second end of the interface. Therefore, the RF penetration is reduced. Optionally the number of interface electrodes per unit length along the x axis is gradually increased within the transition region.

Optionally the interface electrodes may have both a changing width in the x direction, and a changing depth in the y direction, along the transition region. Alternatively, the interface electrodes may have a changing width in the x direction as the depth is constant, i.e. unchanging, or vice versa.

Optionally, the interface region may comprise two central interface electrodes each having a width (in the x direction) that decreases along an/the z axis, and wherein additional interface electrodes within the transition region have a width, along the x axis, that increases in correspondence to the width of the central interface electrodes decreasing.

Optionally, the multipole may have a multipole channel which extends into the transition region, and wherein the additional interface electrodes are formed such that a centreline of the multipole channel (along the z direction) is maintained. The multipole channel may refer to a channel which extends from the multipole, e.g. towards the RF surface. The multipole channel may be referred to as the central multipole channel. Optionally, the inner edges of the two central RF electrodes are configured to be parallel and aligned with the inner edges of the multipole electrodes such that a/the centreline of the multipole channel is maintained. This has the advantage that a pseudopotential barrier is not formed due to a turn in the multipole channel.

Optionally a DC gradient or DC travelling wave may be applied to electrodes of the RF confinement device, e.g. to the plurality of RF electrodes or to additional DC electrodes, so as to force the ions along an/the x axis. By applying a DC gradient or DC travelling wave to electrodes of the RF confinement device, the ions may be forced in a direction different to their initial direction, or they may continue to be forced in their initial direction. Therefore, the ions can be directed in a specific direction for injection/extraction. For example, the ions can be directed towards a DC auxiliary electrode.

The ion guiding system may comprise a first auxiliary DC electrode, configured to apply a force on the ions such that they are directed towards the interface. Optionally the first auxiliary DC electrode may have a surface which is oblique to the x-axis and the z-axis, such that ions forced along an/the x-axis by the DC gradient or DC travelling wave are forced along a z-axis by a force orthogonal to the x-axis, wherein the z axis is perpendicular to the x axis. Optionally, the width in the x direction of the one or more DC electrodes is tapered.

The ion guiding system may comprise a second auxiliary DC electrode wherein the first and second auxiliary electrodes are configured to provide a DC well in the x direction for extracting ions. Optionally the second auxiliary DC electrode may be located in a different location relative to the interface compared to the first auxiliary DC electrode. For example, the first auxiliary DC electrode may be located at a first side of the interface, and the second auxiliary DC electrode may be located at a second side of the interface. Optionally the second auxiliary DC electrode may be located on the opposite side, in the x direction, of the RF surface to the first auxiliary electrode. Therefore, first auxiliary DC electrode and second auxiliary DC electrode may be located on opposing sides of the ion path in the x direction. The ion path is the path that the ions would take based on the electrodes and the voltages applied thereto. Optionally the second auxiliary electrode extends in the same plane as the first auxiliary electrode.

The first and second auxiliary DC electrodes are advantageous as it is possible to use the ion guiding system for injection and extraction by changing the direction of the ions.

The first and/or second auxiliary DC electrodes may be located in the same plane as the plurality of RF electrodes or may be located in a different plane. The plane(s) in which the first and/or second auxiliary DC electrodes are located may be parallel to the plane in which the plurality of RF electrodes are located. The plane(s) in which the first and/or second auxiliary DC electrodes are located may be positioned close to the plane around which the ions are confined.

Optionally the interface electrodes are set at a higher DC potential than the RF surface such that a DC gradient is generated at the interface. When the distance in the y-direction between the surface of each interface electrode and the plane around which the ions are confined decreases along the z-direction in the transition region, this creates a DC gradient at the interface that urges ions in the z-direction. Such a DC gradient is advantageous for a gas filled device as the use of a DC gradient urges ions through the interface which stops the ions getting stuck.

The interface electrodes may be segmented along the z axis to enable an additional DC gradient to be applied.

In another aspect there is a provided a beam switching device for an analytical instrument (e.g. a mass spectrometer), comprising the ion guiding system according to an embodiment described herein and a beam switching ion guide, wherein the ion guiding system is configured to inject and/or extract ions into and out of the beam switching ion guide.

In another aspect there is provided a mass spectrometer comprising the ion guiding system according to an embodiment, and/or the beam switching device.

In another aspect, there is provided an ion mobility spectrometer comprising the ion guiding system according to an embodiment.

### BRIEF DESCRIPTION OF DRAWINGS

Various aspects of at least one embodiment are discussed below with reference to the accompanying figures, which are not intended to be drawn to scale. The figures are included to provide illustration and a further understanding of the various aspects and embodiments and are incorporated in and constitute a part of this specification but are not intended as a definition of the limits of the invention. In the figures, each identical or nearly identical component that is illustrated in various figures is represented by a like numeral. For purposes of clarity, not every component may be labelled in every figure.

FIG. 1A shows a perspective view of an interface between two mechanically identical quadrupole ion guides;

FIG. 1B shows the radial velocity and the axial velocity of ions traversing the interface of FIG. 1A;

FIGS. 2A and 2B show an interface between a quadrupole and RF surface, according to an embodiment;

FIG. 3 shows an interface between a quadrupole and RF surface according to an embodiment;

FIG. 4A shows a perspective view of a simulation model of ion movement between a multipole and RF surface;

FIG. 4B shows a cross-sectional view along the x-y axis of the simulation model of FIG. 4A;

FIG. 5 shows the pseudopotential profile of the centreline X taken down the length of the interface of FIG. 3;

FIG. 6 shows a top-down view of an interface comprising auxiliary DC electrodes, according to an embodiment;

FIG. 7 shows a perspective view an interface according to an embodiment;

FIG. 8 shows the transition of pseudopotential profiles across the length of interface shown in FIG. 7;

FIG. 9 is a graph showing DC gradient generated by 2V wedged DC electrodes;

FIG. 10 is a graph showing simulated ion trajectories from quadrupole to RF surface, with different energy and pressure conditions;

FIG. 11 shows a top down view of an interface according to an embodiment; and

FIG. 12 shows a beam switching device incorporating an ion guiding system according to an embodiment.

### DETAILED DESCRIPTION OF EMBODIMENTS

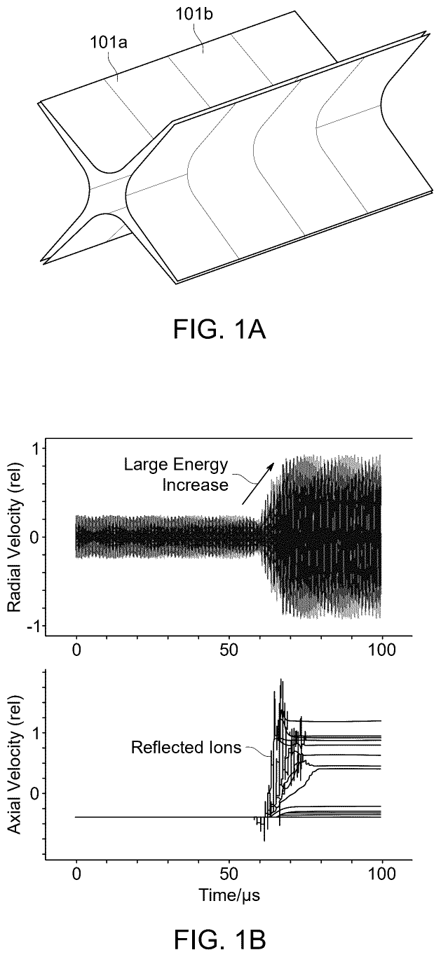

FIG. 1A shows a perspective view of an interface between two mechanically identical 2 mm radius, r₀ quadrupole ion guides. The two quadrupole ion guides 101a and 101b have different frequency 800V radio frequency (RF) signals applied to them, 101a has an RF signal 3.8 Mz applied and 101b has an RF signal 4.2 MHz applied. As ions cross from one quadrupole to the other, they experience a large increase in radial velocity. This increase in radial velocity is shown in FIG. 1B in which the radial velocity is on the y axis, and the time is on x axis. FIG. 1B shows a radial velocity of around 0.2 as the ions travel over the first quadrupole 101a. As shown in FIG. 1B, the ions pass from the first quadrupole 101a to the second quadrupole 101b, i.e. the ions pass over the interface, at around 50 microseconds (μs). It is shown in FIG. 1B that the radial velocity increases to around 0.8, thus showing that there is a large energy increase in the ions as they pass over the interface between the two quadrupoles 101a and 101b. As shown in the second graph of FIG. 1B, the axial velocity of the ions also increases at around 50 microseconds, i.e. at the same time as the large increase in radial velocity described above. The axial velocity of some of the ions is shown to increase from around −0.2 to around 1.5, whilst the axial velocity of the other ions remains constant. Therefore, FIG. 1B shows that a large proportion of the ions are being reflected back along the first quadrupole 101a, rather than passing over the second quadrupole 101b. The problems illustrated in FIG. 1B are due to RF fringe fields, where pseudopotential barriers are formed that may stop or reflect back ions, as shown by the increase in axial velocity. Ions that do cross into the second quadrupole are excited by the pseudopotential barriers, as shown by the increase in axial velocity.

Therefore, as shown in FIG. 1B, there are difficulties in merging different devices. Although FIGS. 1A and 1B show the effects of an interface between two quadrupoles with different frequency signals applied, it will be appreciated that RF fringe fields occur in the merging of higher order multipole ion guides with each other or merging a multipole ion guide with an RF surface or stacked ring ion guide. The multipole ion guide may also simply be referred to as a multipole herein. A quadrupole ion guide may also simply be referred to as a quadrupole herein.

The RF surface described herein may also be referred to as an RF carpet, or RF ion carpet. The RF surface is formed from a plurality of electrodes having a substantially planar surface and configured to receive RF voltages such that there is a voltage phase difference between adjacent electrodes of the plurality of electrodes. In other words, one or more (or each) of the plurality of electrodes may have a substantially planar face. The RF surface may thus generate a substantially planar RF pseudopotential surface parallel to the RF surface when receiving the RF voltages. The plurality of electrodes may be considered to collectively have a substantially planar surface, even if not all of the plurality of electrodes each have a substantially planar face.

The RF surface may be substantially planar but need not be completely flat. For example, the electrodes may include indentations or protrusions or be wedge-shaped to direct or compress an ion beam.

It will be appreciated that although embodiments described herein specifically describe using an interface for a quadrupole and RF surface, the techniques described herein can be used with higher order multipoles.

Known devices use an aperture with applied DC to terminate the fringe field. Although the aperture provides a solution to terminating the fringe field, it has been appreciated by the inventors that use of by using an aperture, a proportion of the ion path loses focus. Therefore, to maintain transmission, ions must be given an increase in energy (eV) to cross between the two devices which is disadvantageous. It has also been appreciated that apertures are weak spots for build-up of contamination that often require regular cleaning and have limitations on gas conductance restriction due to their need to be sufficiently open and thin.

Therefore, it has been appreciated that it would be advantageous to provide an ion guide system which interfaces between a multipole ion guide and an RF surface to avoid pseudopotential barriers and fringe field effects, without using an aperture. It has been realised by the inventors that it is possible to provide a smooth transition between a multipole and RF surface by providing an interface in a transition region. The interface transitions between a first confinement field of the multipole ion guide and a second confinement field of the RF surface. The first confinement field is provided by the plurality of electrodes of the multipole ion guide, and the second confinement field is provided by an RF confinement device which comprises an RF surface having a plurality of RF electrodes. It has been realised that by providing an interface field, which transitions between the first confinement field and the second confinement field, pseudopotential barriers and fringe field effects can be reduced. The confinement fields confine the ions approximately to a plane, where the plane is substantially parallel to the x-z plane formed by the plurality of electrodes. The plane to which the ions are approximately confined may be referred to herein as the ‘plane in which the ions reside’, or the ‘plane in which the ions travel’.

The interface described herein is located in a transition region, which may also be referred to as an interface region and comprises a plurality of interface electrodes configured to provide the interface field. Such an interface is described herein in more detail, with reference to a number of specific embodiments. The transition region is the location, i.e. region, in which the interface is located. The transition region is the area over which the confinement field changes from a multipole confinement field to an RF surface confinement field. As discussed herein, the transition field may provide a smooth, or gradual, transition between the multipole confinement field and RF surface confinement field. In some examples, the transition region may provide a smooth transition between two field structures, wherein one of the field structures is orthogonal to the other. Therefore, the transition region may change the direction of the ions, such that the initial direction of travel of the ions is orthogonal to the final direction of travel of the ions. The ability to extract ions to a multipole enables the use of phase space compression which would previously only be possible in RF surfaces via funnels.

The ions are confined by the confinement device disclosed herein. The confinement device confines the ions approximately to a plane substantially parallel to the first RF surface. In some embodiments the confinement device comprises a second surface, i.e. a top surface, wherein the second surface is located opposite to the RF surface. The first and second surface may also be referred to as the bottom and top plates. The first and second surface are located relative to each other such that the first and second surface substantially overlap.

Although the embodiments herein will be described as having a second RF surface as the top surface, the second surface may alternatively be a DC repeller plate. The same technical considerations apply with the use of a DC repeller plate, and therefore any embodiment described herein could instead be implemented with a DC repeller plate instead of a second RF surface. In ion guiding systems comprising a DC repeller plate (also referred to as a DC counter electrode) it is possible to taper the RF quadrupole electrodes into the DC surface.

A DC repeller plate is configured to apply a repelling voltage that repels the ions towards the RF surface. The DC repeller plate is therefore configured to confine the ion beam between the repeller plate and the RF surface. The repeller plate may be configured to prevent the ion beam from approaching the repeller plate, avoiding contamination and charging effects on the repeller plate. Therefore, by using a confinement device, the ions substantially reside, and travel, approximately in a plane above the lower RF surface. In the embodiment in which the confinement device comprises a second surface, e.g. a DC repeller plate or a second RF surface, the ions reside, and travel, approximately in a plane between the lower RF surface and the top surface.

The disclosure will now be described in relation to specific embodiments. The embodiments described herein are not intended to be limiting and are for illustrative purposes.

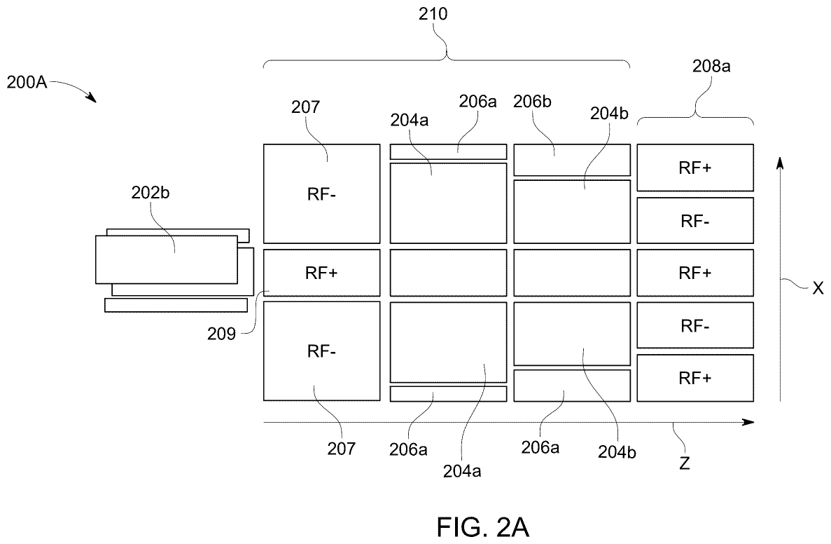

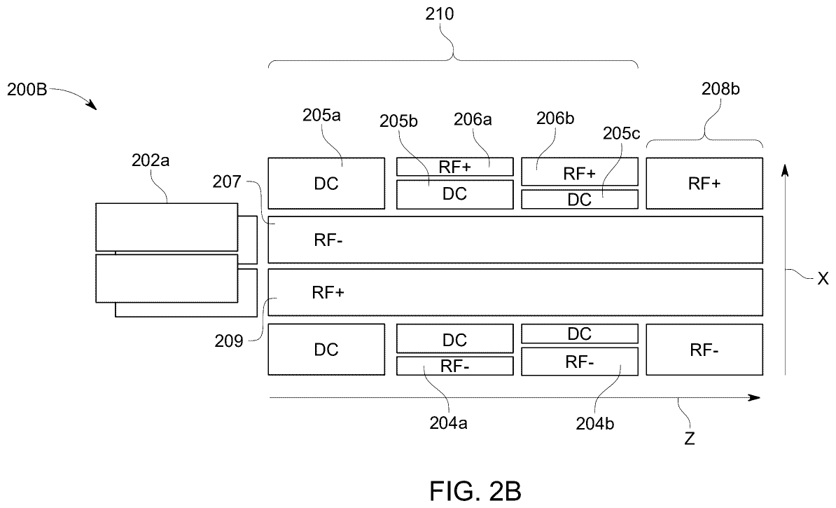

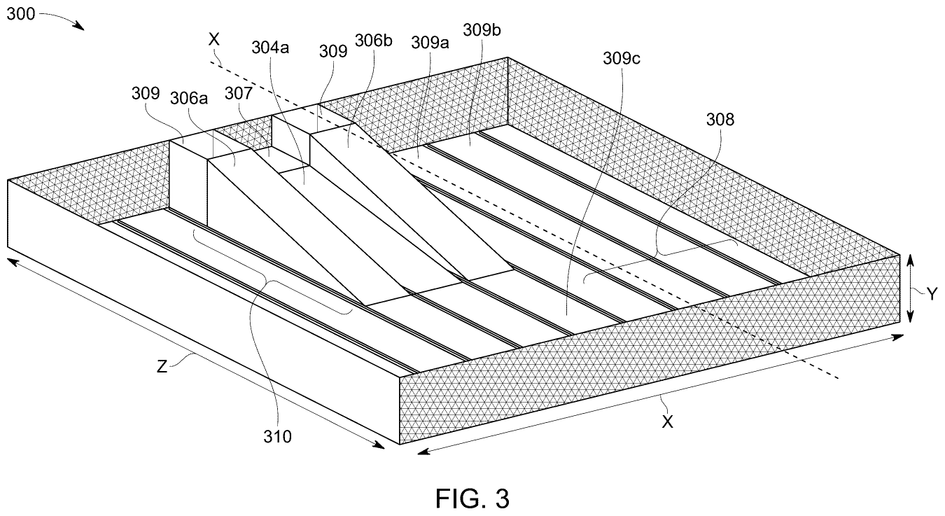

As referred to herein, and illustrated best in FIG. 3, the ion guiding system of the embodiments is described in relation to a three-dimensional coordinate system, such that the ion guiding system has an x axis, y axis and z axis. As shown in FIGS. 2A, 2B and 3, the RF electrodes described herein have a length extending along the z axis. In other words, the z axis may be defined as the longitudinal axis of the confinement device. The RF electrodes have a width extending along the x axis, i.e. the x axis is the direction of the width of the RF electrodes, where the x axis is perpendicular to the z axis. The y axis is perpendicular to both the x and z axes and defines a height of the device. In other words, the y axis is the direction between the first and second surface of the confinement device.

These axes will be used herein to define features. As described herein, the x direction, is along the x axis. The y direction is along the y axis. The z direction is along the z axis.

With reference to FIGS. 2A and 2B, an ion guiding system is shown in accordance with an embodiment of the present disclosure. The ion guiding system will be described with reference to the axes shown in FIGS. 2A and 2B. The ion guiding system in FIG. 2A comprises a regular quadrupole 202b and FIG. 2B comprises a planar quadrupole 202a. The ion guiding systems 200A and 200B, of both FIG. 2A and 2B respectively, are configured to merge the quadrupole 202a or 202b with an RF surface. The RF surface 208a and 208b, for FIGS. 2A and 2B respectively, is shown to the right of the transition region 210, i.e. the transition region is located between the quadrupole and RF surface of each embodiment. It will be appreciated that instead, the electrodes in the region 208a may be part of the interface, such that these electrodes are adjacent to the RF surface, such that the interface has a region which has the same electrode configuration as the RF surface. The embodiment in FIG. 2A and in FIG. 2B each comprise interface electrodes which are configured to create a gradual shift from an RF field similar to the field of the respective quadrupoles, and the field of the final RF surface. In both embodiments, the interface electrodes have an overall wedge-shape such that the interface field provided by the interface electrodes in the transition region transitions between the confinement field of the respective quadrupole and the conferment field of the RF surface. The electrodes are not shown to scale, and there may be more or fewer electrodes than illustrated in the Figures herein.

In system 200A, the quadrupole 202a has two RF− electrodes, and two RF+ electrodes which are located adjacent to the transition region 210. The RF voltage applied to the RF+ electrodes is 180 degrees out of phase with the RF voltage applied to the RF− electrodes. In system 200A the interface within the transition region 210 comprises a plurality of interface electrodes wherein the electrodes extend in the z-x plane, such that the z axis defines their length, the x axis defines their width, and the y axis defines their depth. The configuration of the interface electrodes is symmetric with respect to the x axis. The interface electrodes comprise a plurality of RF+ electrodes 209, 206a, 206b and a plurality of RF− electrodes 207, 204a, 204b. The interface electrodes 207 and 209 generate a field similar to the field generated by the quadrupole 202a. The number of electrodes within the interface increases within the transition region, such that the number of interface electrodes is greater than the number of electrodes in the quadrupole. The number of interface electrodes is less than the number of electrodes in the RF surface. Therefore, the interface region provides a transition between the number of multipole electrodes and number of RF surface electrodes. Therefore, the RF penetration is reduced within the interface due to the increase in number of electrodes. The number of electrodes is increased due to the reduced width of the interface electrodes (and due to the reduced spacing between the centres of the electrodes), as will be described herein, but it would also be possible to use a constant electrode width and to reduce the spacing between the centres of electrodes. In other words, the number of electrodes per unit length is increased within the interface region, resulting in a reduced RF penetration to the plane around which the ions are confined (as will be described in more detail herein). It will be appreciated that in some embodiments described herein, the reduced width of electrodes enables an increase in number of electrodes.

The interface RF− electrodes 207, 204a, 204b reduce in width, i.e. they reduce in size along the x direction, as the distance in the z direction from the quadrupole 202a increases. In other words, the RF− electrodes 207 adjacent to the quadrupole 202a have a greater width than the RF− electrodes 204b adjacent to the RF surface 208a. The interface region comprises a row of RF+ electrodes 209 which have a constant width throughout the length of the interface, in the z direction. These may be referred to as the inner RF+ electrodes, or the central RF+ electrodes. The interface region also comprises RF+ electrodes 206a and 206b which have a varying width along the interface. These RF electrodes 206a and 206b are herein referred to as outer RF+ electrodes. The outer interface RF+ electrodes 206a, 206b increase in width, as the distance from the quadrupole in the z direction increases, where the width of the electrode extends along the x axis. In other words, the outer RF+ electrodes 206a closest to the quadrupole have a smaller width than the RF+ electrodes 206b adjacent to the RF surface 208a. Therefore, the interface electrodes are shaped such that the width of each of the plurality of interface electrodes at a first end of the interface is smaller than the width of each interface electrode at the second end of the interface. In other words, the width of interface electrodes further away from the multipole, in the z direction, are smaller than the width of interface electrodes closer to the multipole, in the z direction. The RF− and RF+ electrodes increase and decrease in width, respectively, by the same amount, so that the width of the ion guiding system remains constant from the electrodes 207 and 209, which are located adjacent to the quadrupole, to the RF surface 208a, as the distance in the z direction from the quadrupole increases. The RF+ and RF− electrodes are all constant width at the RF surface 208a. The change in width of the electrodes within the interface results in a transition of the field from the quadrupole 202a to the RF surface 208a. The electrodes of this embodiment are axially segmented to allow a DC or RF gradient to be applied to the interface. In other words, the RF− interface electrodes 207, 204a, 204b, and 208a are segmented, rather than being one continuous RF− electrode. In other embodiments, the interface electrodes may not be segmented, for example the electrodes 207, 204a, 204b, and 208a may be one continuous electrode.

It will be described herein that the interface electrodes have a changing width and/or changing depth. However, it will be appreciated that in embodiments in which the electrodes are segmented such that the interface comprises a plurality of interface electrodes, each individual interface electrode may be rectangular in shape, such that each individual interface electrode has a constant width and/or depth. However, the overall interface may reduce in width and/or depth, by the interface electrodes forming a width which decreases in a step-wise manner. Therefore, it will be understood by the skilled person that description of interface electrodes having a decreasing or increasing width or depth is intended to cover embodiments in which interface electrodes individually have constant widths and depths, but the interface as a whole has a changing width and/or depth.

FIG. 2B has a similar arrangement and similar concepts apply to FIG. 2A.

The interface comprises RF+ and RF− electrodes whose width changes in the x direction. However, the interface electrode arrangement is not symmetric about the x axis. Instead, the interface comprises one central RF− electrode 207 and one central RF+ electrode 209 which are both elongated electrodes and are continuous from the RF surface 208b to adjacent to the quadrupole. For simplicity the interface will be considered as being two halves, one half comprising the RF− central RF electrode 207 and one half comprising the central RF+ electrode 209. The half of the interface comprising the RF− electrode 207 further comprises RF+ electrodes 206a and 206b of increasing widths as the distance from the quadrupole in the z direction increases. The half of the interface comprising the RF+ electrode 209 further comprises RF− electrodes 204a and 204b of increasing widths as the distance from the quadrupole in the z direction increases. The arrangement of the RF− and RF+ electrodes is symmetric about the x axis, in that the sizes of the RF− and RF+ electrodes are equal at any point along the z axis.

As shown in FIG. 2B the interface further comprises DC electrodes 205a, 205b, and 205c which have a width decreasing in the x direction as the distance in the z direction from the quadrupole 202b increases. The DC electrodes are located on the inside of the interface, i.e. the DC electrodes are not located on the periphery of the ion guiding system. Instead, the DC electrodes are adjacent to the central RF+ and RF− electrodes 207 and 209. Therefore, in the interface region, in which there are RF+ 206a, 206b electrodes and RF− electrodes 204a, 204b, the DC electrodes are located in between the central RF+ 207 and RF− electrodes 209, and the RF+206a, 206b and RF− 204a, 204b electrodes. The DC electrodes decrease in width proportional to the increase in width of the RF+ and RF− electrodes 206a, 206b, 204a and 204b, such that the interface remains a constant width in the x direction as the distance in the z-direction from the quadrupole increases. In other words, the RF+ electrodes and RF− electrodes 206a, 206b, 204a and 204b, and DC electrodes 205a, 205b, 205c taper in shape, whereas the central RF+ and RF− electrodes remain constant in width along the z axis. The DC electrodes enable a DC gradient to be applied to the interface.

In both embodiments illustrated in FIGS. 2A and 2B, the varying of width of the RF electrodes provides a resulting interface confinement field which transitions the field from the quadrupole confinement field to the RF surface confinement field. Therefore, the transition region enables ions travelling along this plane to have a smooth transition between the confinement field of the quadrupole and the confinement field of the RF surface. Therefore, the interface described in FIGS. 2A and 2B avoids fringe fields being caused by the interface of the two devices, thus avoiding the problems described above. It will be appreciated that although FIGS. 2A and 2B only illustrate two types of quadrupole, a higher order multipole could be used in conjunction with the same inventive techniques described with respect to these Figures.

It has been realised that a problem can emerge when using the ion guiding system illustrated in FIGS. 2A and 2B, when the electrodes of the RF surface 208a have a similar spacing, i.e. inter-electrode spacing in the x direction and/or distance between surfaces in the y direction, and similar width, in a direction along the x axis, as the electrodes of the quadrupole 202a, 202b. The problem is that the ion guiding system essentially creates a stack of RF channels rather than a broad low field region. In other words, it has been realised that it is not desirable to have strong RF pseudopotential forces in the plane in which the ions are approximately confined, as this will create barriers to ion motion. Therefore, it has been realised that it is preferable for RF penetration to the central plane of the RF surface to be low. The central plane is defined by the plane located between the upper and lower surfaces of the RF confinement device, wherein the central plane is substantially parallel to the plane in which the RF electrodes are located. The central plane is the plane around which the ions are confined. In other words, it is preferable for the RF penetration, in the direction perpendicular to the plane in which the RF electrodes are located, to be low. In other words, it is preferable for the RF penetration to be low in the y-direction, as shown in FIG. 3, wherein the RF electrodes are located in the z-x plane. It has been realised that composing the RF surface with RF electrodes having a thin width, in the x direction, achieves this low penetration, due to the greater number of electrodes per unit length. It has also been realised that by, alternatively or additionally, having a wide space, in the y direction, between the two opposing surfaces of an RF confinement device (as described herein) would be provide a low RF penetration to the central plane. In other words, it is possible to reduce RF penetration to the central plane by providing an increased distance between the electrodes of the upper and lower surfaces of an RF confinement device. In some embodiments in which the confinement device comprises two RF surfaces, there is an increased distance between the RF electrodes of a first RF surface and the electrodes of a second RF surface. If the RF electrodes are surface mounted solid electrodes, they may have a width, in the x direction, greater than or equal to around 0.5 mm. The RF electrodes may have a width of around 2 to 5 mm. If the RF electrodes are printed circuit board (PCB) printed electrodes, the electrodes may have a smaller width than the surface mounted solid electrodes described herein. The lower and upper surfaces of the RF confinement device may have a plate spacing equal to or greater than 1 mm.

Examples of interfaces for use in an ion guiding system are described herein. The interfaces provide a transition between the confinement fields of the multipole ion guide and the RF surface, where the multipole surface spacing may be smaller than the RF surface spacing, and/or the multipole electrode width may be greater than the RF surface electrode width.

An embodiment in which an interface is provided to transition between the spacing of the first and second surfaces of an RF confinement device and the spacing between the surfaces in a multipole is described in relation to FIG. 3.

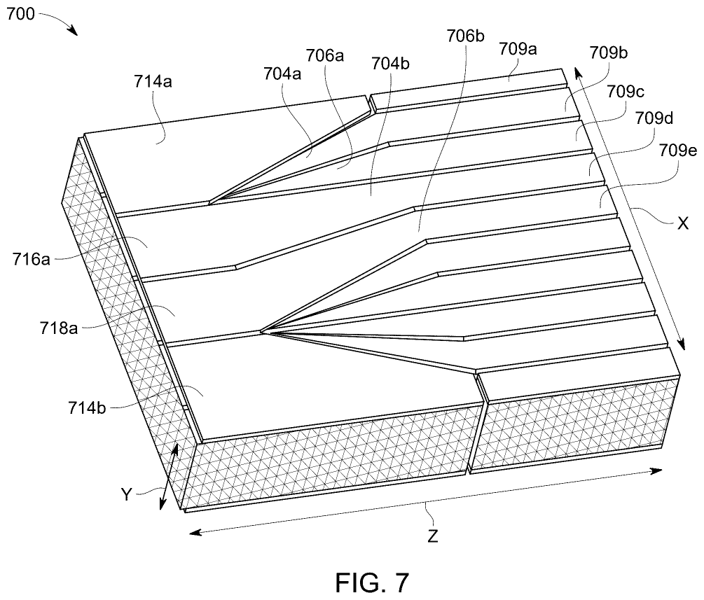

An embodiment in which an interface is provided to transition between the width of the RF electrodes and the width of the multipole electrodes is described in relation to FIG. 7.

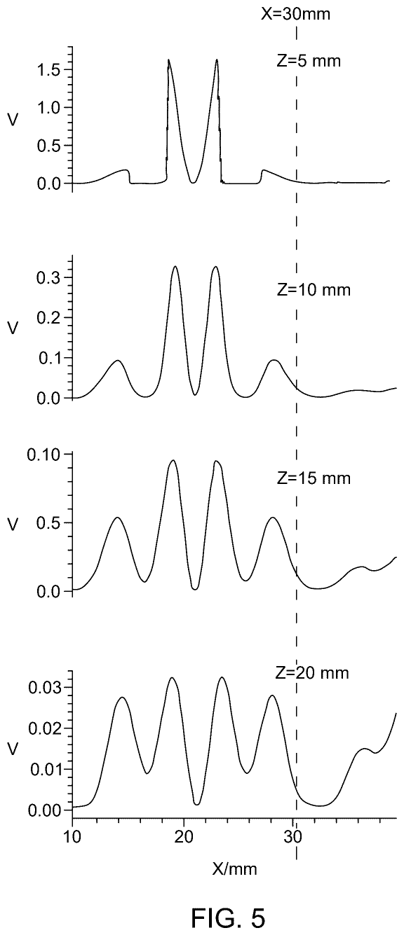

FIG. 3 illustrates an interface and RF surface configured to be used in an ion guiding system according to an embodiment. FIG. 3 shows centreline X which is taken along the length of the interface and will be discussed in relation to FIG. 5. The interface of the system 300 comprises electrodes 307 and 309, which are adjacent to the quadrupole and produce a similar field to the quadrupole. The electrodes 307 and 309 each have a height in the y direction, which is greater than the average height of a corresponding interface electrode 306a, 306b and 304a which is located further from the quadrupole, in the z direction. FIG. 3 shows an RF surface having a plurality of RF electrodes, for example electrodes 309a, 309b and 309c. The RF surface is located adjacent to a transition region 310 in the z direction, such that the RF surface is located at the end of the interface electrodes. The RF surface is also located adjacent to the interface electrodes in the x direction. In other words, the interface may have a smaller width in the x direction than the RF surface, such that the RF surface comprises RF electrodes 309a and 309b which are located either side of the interface, as shown in FIG. 3. In some embodiments the interface electrodes may be mounted onto the RF surface, such that in the transition region, i.e. at the portion at which there is an interface, the RF electrodes are covered by interface electrodes. At the edge of the outermost interface electrodes, i.e. when the transition region ends, the RF electrodes are exposed and therefore define an RF surface. As shown in FIG. 3, each of the RF electrodes 309a and 309b illustrated in FIG. 3 has a planar surface parallel to the z axis (i.e. parallel to the z-x plane). The RF electrodes, where some example RF electrodes have been labelled as 309a, 309b, and 309c, may comprise elongated electrode plates and may be arranged to be parallel to each other. FIG. 3 is for illustrative purposes, and therefore there may be more or fewer RF electrodes than shown in FIG. 3. Although only one RF surface is shown in FIG. 3, it will be appreciated that the ion guiding system 300 may comprise a second surface (i.e. plate) located opposite the RF surface, where the second surface may be any RF surface or DC repeller plate described herein, to form an RF confinement device. The ion guiding system shown in FIG. 3 comprises a transition region 310, wherein the transition region comprises an interface which is configured to transition between a confinement field generated by the multipole ion guide, and the confinement field generated by the RF surface 308. The transition region comprises an interface, having a plurality of interface electrodes 307, 309, 306a, 304a, and 306b. It will be appreciated that there may be more or fewer interface electrodes than illustrated in FIG. 3. As described herein, the electrodes have an alternating radio frequency phase applied to each of the plurality of RF electrodes and each of the plurality of interface electrodes. Interface electrodes 306a and 306b therefore have the same radio frequency phase applied to them, which is alternate to the radio frequency phase applied to the electrode 304a.

The multipole ion guide has a first surface separation between its plates, and therefore at the edge adjacent to the multipole ion guide, i.e. at the intersection between the multipole ion guide and interface, the interface electrodes 307, 309, 306a, 306b and 304a have a first depth, wherein the depth is in a direction along the y axis, i.e. the depth is in the y direction. The first depth is such that in use, the spacing between the interface electrodes and the plane in which the ions approximately reside, i.e. the plane around which the ions are confined, or the plane in which the ions travel, from the quadrupole to the RF surface, is substantially the same as the spacing between the surface of the plurality of multipole electrodes and the plane in which the ions approximately reside. The depth of the electrodes extends in the direction perpendicular to the plane in which the plurality of RF electrodes extend. Therefore, for further clarification, the depth of an electrode in the y direction is considered to be the distance between the upper and lower surface of the electrode, wherein each of the upper and lower surfaces of the electrode are in a plane parallel to the plane in which the RF electrodes are located. The depth of the electrode could also be referred to as the width of the electrode in the y direction. Therefore, as shown in FIG. 3, the multipole electrodes have a depth which is greater than the depth of the RF electrodes, where the depth is in the y direction.

The spacing between the surface of the RF electrodes and the plane approximately in which the ions travel is different to the spacing between the multipole ion guide surface and the plane approximately in which the ions travel. The distance between the plurality of RF electrodes and the plane approximately in which the ions travel is greater than the distance between the plurality of multipole electrodes and the plane approximately in which the ions travel. In other words, the distance between two opposing surfaces of the RF confinement device is greater than the distance between the two opposing surfaces of the multipole. The interface electrodes are shaped such that the distance between the surface of the interface electrode and the plane approximately in which the ions travel decreases along the transition region. The interface electrodes 306a, 306b and 304a are tapered such that the interface electrodes provide a smooth transition between the spacing between the RF electrodes and the plane approximately in which the ions travel, and the spacing between the quadrupole electrodes and the plane approximately in which the ions travel, as described above. In other words, the interface electrodes 306a, 306b and 304a are wedge shaped in the y direction, i.e. the interface electrodes extend along the y-axis. The interface electrodes therefore extend perpendicular to the plane around which the ions are confined. Therefore, the interface electrodes have a substantially triangular cross section in the z-y plane. The interface electrodes 307 and 307 may have substantially the same depth, in the y direction, as the quadrupole electrodes to provide a similar field as the quadrupole.

In one example, there is a transition region between a 2 mm r₀ standard quadrupole and an RF surface device having a 10 mm spacing between opposing RF surfaces. In this example the RF surface is composed of RF electrodes having 4 mm wide plates in the x direction, i.e. in the plane parallel to the plane in which the RF electrodes reside. The transition region comprises a plurality of interface electrodes which transition between the quadrupole spacing and the RF surface spacing over a 20 mm length. In other words, the interface electrodes have a length, in the z direction, of 20 mm, wherein the z direction is perpendicular to both the x and y directions. The z direction is the direction in which the elongated electrode plates extend, as shown in FIG. 3. The RF surface and quadrupole may share an applied 2 MHz 200V RF.

The interface electrodes may be mounted onto the same substrate from which the RF surface is formed. However, the interface electrodes may instead be separate to the RF surface, i.e. the interface may be placed adjacent to the RF surface in use but mechanically separate to the RF surface. In such an embodiment, the interface may be joined to the RF surface by use of bolts, or any other suitable method. Therefore, the interface may be configured to be used with a device other than an RF surface. Furthermore, the interface may be separate from the multipole such that the interface may be configured to interface between two RF devices other than a multipole and RF surface.

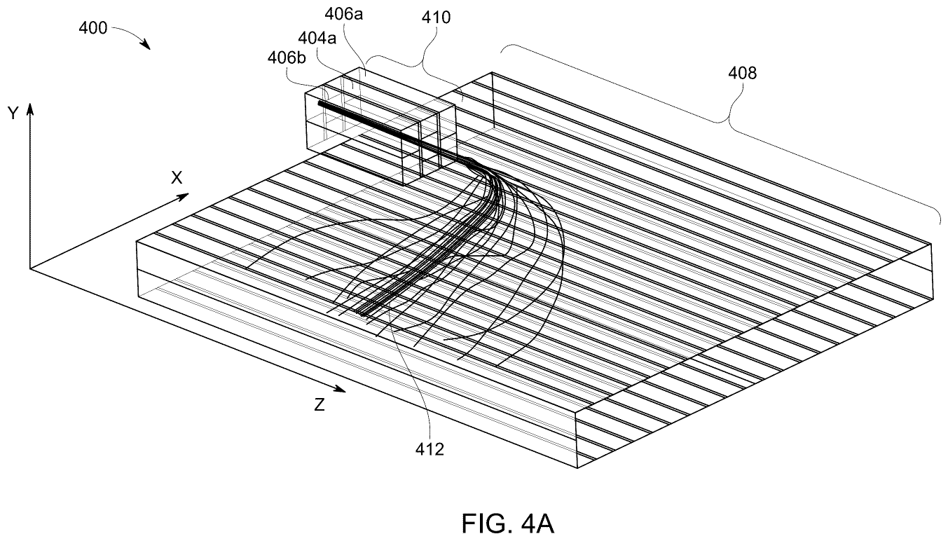

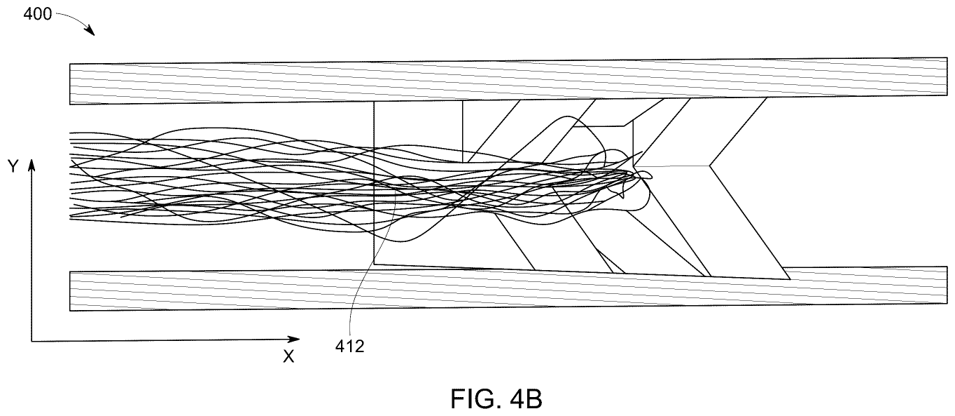

FIGS. 4A and 4B shows a system 400 for use in an ion guiding system according to an embodiment. As described in relation to the configuration of FIG. 3, there may be a second surface of the RF confinement device, as is shown in FIGS. 4A and 4B. The system 400 may have the same features as the system 300 as described in FIG. 3, in particular the interface comprises interface electrodes which are wedge shaped in the y direction. It will be appreciated that the proportions and sizes of features may be different to those described in relation to FIG. 3. The system 400 differs from system 300 in that the RF surface 408 of the system 400 is subjected to a small applied DC gradient or a travelling DC wave. Therefore, once the ions 412 have been injected into the RF confinement device, the ions curve once they have left the confinement field of the multipole, due to the DC gradient or travelling DC wave applying a force to the ions within the RF confinement device. The DC gradient or travelling DC wave is applied in direction perpendicular to the plurality of RF elongated electrodes. Therefore, in this example, the ions initially travel in a first direction, i.e. along the multipole channel, in a direction parallel to the plurality of RF electrodes. The ions are subjected to a force which is in a direction perpendicular to their initial path. Therefore, the ions travel in a second direction which is different to their initial direction, due to the perpendicular DC gradient or travelling DC wave being applied to the RF surface. In the simulation model of FIGS. 4A and 4B, ions with mass charge ratio (m/z) of 200 are injected with energy 0.1 eV into either a gas free or 0.1 mbar nitrogen (N₂) environment. A nitrogen environment will cause the ions to scatter, as shown in FIGS. 4A and 4B. A gas force may additional or alternatively be used to apply a force to the ions in the x direction. In other words, a gas flow is provided so as to force the ions along an x axis.

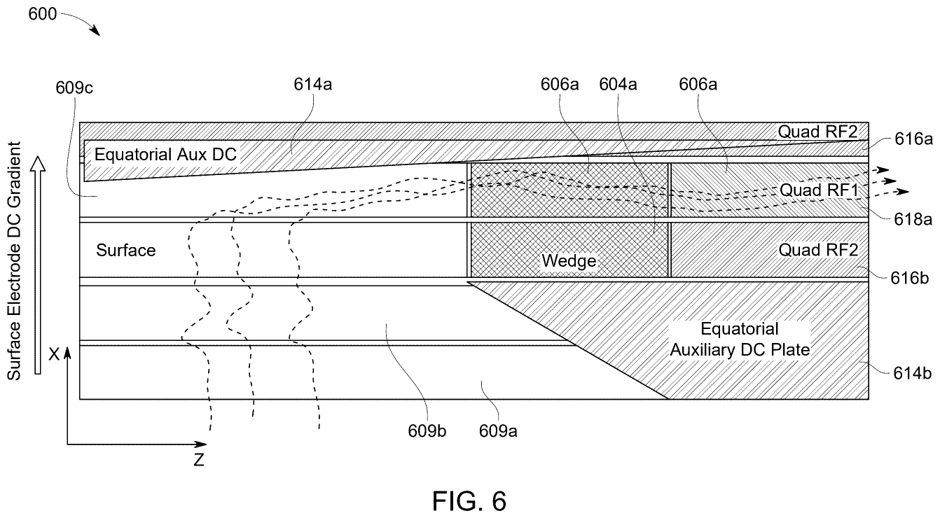

Another DC gradient may be applied in the z direction to the interface 410 by setting the interface electrodes 406a, 406b and 404a at a higher DC potential than the RF surface, resulting in a DC gradient being generated along the interface. Such a DC gradient is advantageous for a gas filled device as the use of a DC gradient urges ions through the interface which stops the ions getting stuck. A DC gradient may alternatively be applied to the interface using wedge shaped DC electrodes, as will be described herein in relation to FIG. 6.

FIG. 4B shows a cross-sectional view of the x-y plane of the simulation model of FIG. 4A. FIG. 4B illustrates the three-dimensional structure of the interface, the confinement of ions in the y direction between two RF surfaces, and the change of direction of the ions due to a DC gradient or travelling DC wave.

FIG. 5 shows the pseudopotential profile of the centreline X, wherein the centreline X is shown as a broken line in FIG. 3. In this example the multipole is a quadrupole. The centreline X is taken down the length of the interface, i.e. in the z direction. FIG. 5 shows the pseudopotential profile at z=5 mm, z=10 mm, z=15 mm, and z=20 mm, wherein z=0 is the start of the interface, i.e. the start of the transition region. FIG. 5 shows the voltage as a function of distance in the x direction. For clarity, each of the graphs uses the same x axis as shown at the bottom of FIG. 5. As shown in FIG. 5, the pseudopotential well initially has a depth of 1.5V when z=5 mm. Therefore, the pseudopotential well has the highest depth at the at the start of the interface region. As shown at z=10 mm, the pseudopotential well depth has reduced to around 0.3V. At z=15 mm the pseudopotential well depth has reduced to around 0.10V. At z=20 mm the pseudopotential well depth has reduced to 0.03V. Therefore, over the length of the interface along the z axis, the pseudopotential well depth reduces by over a factor of 50 as the quadrupole is replaced by the RF surface character. The pseudopotential profile at z=5 mm has two prominent peaks, which are symmetric with respect to the x axis, i.e. the peaks are the same height and shape. As the distance along the z axis increases, i.e. the distance from the quadrupole increases, the pseudopotential profile changes such that there are two additional peaks formed either side of the two initial peaks. At z=20 mm the pseudopotential profile comprises four peaks which each have around the same voltage, which is due to the RF surface character. There is a distortion at x=30 mm and above (wherein x=30 mm is illustrated in each graph by the broken line), which is due to the termination of the interface region in the x direction, where the termination of the interface region in the x direction is illustrated and described in relation to FIG. 3. In other words, the interface has a finite width in the x direction, and at the termination of the interface, the pseudopotential region changes, as can be seen in FIG. 5.

The systems described in FIGS. 3, 4A, 4B and 5 are configured for use for ion injection, wherein ions are injected from a multipole. However, it has been appreciated that such systems may not be suitable for ion extraction. Ion extraction may be achieved by creating a DC well in the x direction aligned to the multipole channel, and a DC gradient in the z direction to move ions into the interface. The associated phase space compression also favours buffer gas pressure for ion thermalisation.

Therefore, a system suitable for ion extraction will now be described in relation to FIG. 6. It has been realised that it is possible to use additional wedged DC guard electrodes to cause the ions to travel in a direction substantially orthogonal to the direction of motion of ions caused by the RF surface. Therefore, the wedge shaped DC electrodes described herein direct ions into the multipole channel, as well as preventing ions moving to other unwanted areas. Such DC guard electrodes (otherwise referred to as “auxiliary electrodes”) may be integrated into the top and/or bottom surfaces of the RF confinement device or may be solid electrodes that bridge some or all of the space between surfaces of the RF confinement device, or alternatively as a third equatorial layer suspended between the surfaces of the RF confinement device. In the latter case the DC guard electrodes may be composed of laser cut sheet metal, with mounting points far away from the active RF area to avoid the DC guard electrodes interfering with the RF surfaces.

FIG. 6 illustrates an ion guiding system 600 according to an embodiment. As described in relation to the configuration of FIG. 3, the second surface of the RF confinement device is not shown. The system 600 may have the same features as systems 300 or 400 described in relation to FIGS. 3 and 4. The quadrupole electrodes in this embodiment are located adjacent to the interface electrodes 606a and 604a. The quadrupole electrodes have an alternating radio frequency phase applied to each of the plurality of quadrupole electrodes, such that the quadrupole electrodes 616a and 616b have an opposite RF phase to the quadrupole electrode 618a. In addition to the features of systems 300 and/or system 400, the system further comprises one or more equatorial auxiliary DC electrodes, also referred to herein as auxiliary DC electrodes. In the example configuration illustrated in FIG. 6, the auxiliary DC electrodes are located at the edge of the RF surface, and the edge of the interface. The auxiliary DC electrodes may be located only in the interface region or may be located in each of the RF surface, interface region and the quadrupole electrodes, or may be located only across the interface region and quadrupole electrodes. In the embodiment illustrated in FIG. 6, there are two equatorial auxiliary DC electrodes 614a and 614b. The first auxiliary DC electrode 614a spans the width of most or all of the ion guiding system. The electrode 614a is located at the edge of the device such that it overlaps with one of the outermost RF surface electrodes 609c, one of the outermost electrodes of the transition region 606a (i.e. the outermost interface electrode), and one of the outermost quadrupole electrodes 616a. The electrode 614a has surface which is oblique to the x and z axes. In this example the first auxiliary DC electrode is wedge shaped, such that the width of the electrode, in the x direction, is greatest at the region of the electrode 614a which overlaps the RF surface electrodes. The width of the electrode 614a, in the x direction, is smallest at the portion which overlaps the outermost quadrupole electrode 616a. The first auxiliary DC electrode 614a is therefore wedge shaped, i.e. tapered, such that its width decreases in the x direction as the auxiliary DC electrode 614a approaches the quadrupole ion guide. Alternatively, the wedge shaped first auxiliary DC electrode 614a may be located at the periphery of the ion guiding system such that it does not overlap the RF electrodes, interface electrodes, or quadrupole electrodes. As will be described below in the below description of FIG. 6, the ion guiding system may comprise a second auxiliary DC electrodes. The first and/or second auxiliary DC electrode may be located in the same plane as the plurality of RF electrodes, or in a different plane to the plurality of RF electrodes. When the first and/or second auxiliary electrodes are in a different plane to the plurality of RF electrodes, the plane on which the first and/or second auxiliary electrodes are located may be parallel to the plane in which the plurality of RF electrodes are located.

As mentioned above, the ion guiding system 600 further comprises a second auxiliary DC electrode 614b which is located on the opposite side of the interface to the first auxiliary electrode 614a. In other words, the second auxiliary DC electrode 614b is located on the other side of the interface region in the x direction. The second auxiliary DC electrode 614b is located in a plane which is the same as or substantially parallel to the plane in which the first auxiliary DC electrode 614a is located. Therefore, the second auxiliary DC electrode 614b is located adjacent to one of the outermost electrodes of the transition region 604a (i.e. the outermost interface electrode), and one of the outermost quadrupole electrodes 616b. In the embodiment of FIG. 6 the second auxiliary DC electrode 614b is located such that it overlaps two of the RF surface electrodes 609a and 609b. Alternatively, the second auxiliary electrode 614b may be located at the periphery of the ion guiding system. The second auxiliary electrode 614b is shorter in length in the z direction than the first auxiliary electrode 614a. The second auxiliary electrode 614b does not extend past the interface electrodes 604a and 606a, i.e. the second auxiliary electrode 614b has a length in the z direction equal to the sum of the lengths of the interface electrodes and the parts of the quadrupole electrodes 616a, 616b that overlap with the RF surface. The second auxiliary electrode 614b has a tapered portion which extends over substantially the same length as the interface electrodes 604a and 606a to provide a DC gradient which changes over the same length as the interface portion. The remaining length of the second auxiliary electrode 614b may be rectangular, or another shape. However, it will be appreciated that the second auxiliary electrode 614b may be any suitable shape. For example, the second auxiliary electrode 614b may be a rectangular shape.

The ion guiding system 600 may comprise the first and second auxiliary electrodes 614a and 614b as described above to provide an ion guiding system which is suitable for ion extraction. As described herein, ions initially move in a direction perpendicular to the direction in which the RF surface electrodes extend, due to the DC gradient or DC travelling wave being applied across the plurality of RF electrodes, or due to a gas force (by providing a gas flow) being applied to the ions. The ions move towards the first auxiliary DC electrode, where a force is applied to the ions in a direction orthogonal to their initial movement, due to the oblique surface of the first auxiliary DC electrode. The ions therefore are forced in a direction towards the interface, wherein the interface is located at a 90-degree angle to the direction in which the ions are forced along RF surface. Therefore, a DC gradient (or alternatively a travelling DC wave and/or a gas force) applied across the RF surfaces pushes ions up to the top of the device, i.e. perpendicular to the direction in which the RF electrodes extend, whilst the wedged shape of the auxiliary DC electrodes transforms that force into lateral movement, pushing ions into the entrance of the transition region. It will be appreciated that the ions may enter the RF surface at a different angle to that shown in FIG. 6, in which case the ions will not have the same ion path as shown in FIG. 6, however the first auxiliary DC electrode will generate a force on the ions which is in the direction of the interface region, as described above.

The second auxiliary DC electrode 614b, in combination with the first auxiliary DC electrode 614a, provides a DC well in the x direction which is aligned with the quadrupole channel. This enables the ion guiding system 600 to be used for ion extraction. The shape of the second auxiliary DC electrode 614b results in ions being pushed laterally around the wedge shaped electrodes towards the entrance of the interface, i.e. towards the quadrupole electrodes, however this shape is optional.

Instead, the ion guiding system could comprise a rectangular auxiliary DC electrode to provide a DC well.

In one embodiment, which is not shown, a lateral DC gradient could be applied to the system 600 via segmentation of the quadrupole and/or the interface electrodes. This segmentation uses the same techniques as those illustrated in FIGS. 2A and 2B and their accompanying description. In this embodiment, the DC gradient in the z-direction could either be provided by a combination of the use of auxiliary DC electrodes and segmentation of the quadrupole and/or interface electrodes, or the DC gradient in the z-direction may be provided solely using segmentation of the quadrupole and/or interface electrodes.

As described herein, wedge shaped interface electrodes may extend in the y direction (as described in FIG. 3), i.e. the electrodes may extend in a plane perpendicular to the plane in which the RF electrodes are located. In such a system the RF surface guide reduces the centre plane RF penetration by increasing the distance between opposing surfaces.

As described above, additionally or alternatively the ion guiding system may reduce the centre plane RF penetration by having thin RF electrodes, as shown in FIG. 7. FIG. 7 illustrates an ion guiding system 700 according to an embodiment. As described in relation to other Figures, the second surface of the RF confinement device is not shown, wherein the RF confinement device comprises a first RF surface, and a second surface which may be a second RF surface or a DC repeller plate, as described herein. The system 700 has the same or similar features as the features described in the other embodiments described herein.

As described in relation to FIG. 6, the system 700 comprises two auxiliary DC electrodes 714a and 714b. The two auxiliary DC electrodes are located on either side of interface electrodes 716a and 718a, such that the two auxiliary electrodes are located at the periphery of the device. The interface electrodes 716a and 718a provide a field similar to the field of the multipole electrodes. In the embodiment of FIG. 7, the auxiliary DC electrodes do not overlap the RF surface or interface electrodes 704a, 704b and 706a, and instead are located adjacent to the interface electrodes 716a and 718a which are adjacent to the multipole. The auxiliary DC electrodes have a tapered portion, i.e. there is a portion of each of the auxiliary DC electrode which is wedge shaped. The tapered portion of the DC electrodes is substantially the same length in the z direction as the tapered portion of the interface electrodes. In other words, the portion of the one or more DC electrodes which overlap the transition region are tapered. The remaining part of the auxiliary DC electrodes, i.e. the non-tapered portion, may be any suitable shape such as rectangular. The auxiliary DC electrodes have a reduced width in the x direction as the distance from the multipole ion guide increases in the z direction. In other words, the auxiliary DC electrodes have a smaller width in the x direction at their end nearest to the RF surface, wherein the x direction is perpendicular to the direction in which the elongated RF electrodes 709a, 709b, 709c, 709d, 709e extend. The auxiliary DC electrodes may be +2V DC guard electrodes which are wedge shaped to provide a DC gradient, where such a wedge shape provides the same effect as described in FIGS. 4 and 6.

The system 700 comprises an interface having one or more interface electrodes where the number of electrodes increases within the interface region. In other words, a second end of the interface has a greater number of electrodes (per unit length) than a first end of the interface. The first end is the end adjacent to the multipole, and the second end is the end adjacent the RF surface. Therefore, the interface electrodes provide a transition between the number of electrodes of the multipole and the number of electrodes of the RF surface. The interface electrodes of this embodiment are wedge shaped in the x direction, so that their width, in the x direction, decreases or increases towards the RF surface, as illustrated in FIG. 7. In other words, the one or more interface electrodes may be wedge shaped such that their width changes in the plane in which the plurality of RF electrodes are located, i.e. in the z-x plane. In the illustrated embodiment of FIG. 7, the wedge-shaped interface electrodes have a substantially similar depth, in the y direction, to the plurality of RF electrodes, i.e. the one or more interface electrodes 716a, 718a, 704a, 706a, 704b do not have a different depth in the y direction to the RF electrodes 709a, 709b, 709c, 709d, 709e.

In the embodiment of FIG. 7, the multipole and RF surfaces have the same plane spacing, i.e. the distance in the y direction between the plane of the electrodes and the plane about which the ions travel is substantially equal for the multipole and RF surfaces.

The interface described in relation to FIG. 7 has a plurality of interface electrodes, where some of the interface electrodes have been labelled 704a, 706a, 704b in FIG. 7. The shape of the plurality of interface electrodes provides a transition between the width of the RF electrodes and the width of the multipole electrodes. By having one or more interface electrodes, which each have a smaller or larger width at the end closest to the RF surface, the interface provides a confinement field in the transition region which smoothly transitions between the confinement field of the multipole and the confinement field of the RF surface. Each of the plurality of RF electrodes have a smaller width in the x-direction than the multipole electrodes, such that there are more RF electrodes than multipole electrodes in the ion guiding system 700, as the width in the x direction of the ion guiding system is substantially constant. Therefore, due to the RF electrodes having a smaller width than the multipole electrodes, more RF electrodes are present in the ion guiding system 700. Therefore, the ion guiding system 700 also comprises more interface electrodes than multipole electrodes. There are a greater number of interface electrodes at the end of the transition region closest to the RF surface compared to the number of interface electrodes at the end of the transition region closest to the multipole. In other words, additional electrodes are formed within the transition region.

As illustrated in FIG. 7, the interface electrodes may each have different shapes and proportions of tapering. In this example there are two initial interface electrodes 716a and 718a which are located adjacent to the multipole and have a width in the x direction which is similar to the width of the multipole electrodes to provide a similar field to the multipole electrodes (not shown here). Therefore, to transition from the width of the initial two interface electrodes 716a and 718a to an increased number of RF electrodes (in this case ten RF electrodes), the interface electrodes will be required to reduce the width of the initial two interface electrodes 716a and 718a to provide two RF electrodes with a tapered width compared to the initial two interface electrodes. It is shown in FIG. 7 that the initial interface electrodes 716a and 718a are continuous with the tapered RF electrodes described above, such that the initial interface electrodes 718a and 716a have a non-tapered portion and a tapered portion. However, for clarity here, we will describe the tapered RF electrodes, which are formed by reducing the width of the initial interface electrodes, as separate tapered interface electrodes 704b and 706b.

In the example shown in FIG. 7, eight additional RF electrodes are also created to result in the same number of RF electrodes as the RF surface. These additional electrodes are formed at the interface between the initial two interface electrodes and the tapered interface electrodes. The shape and tapering of the tapered interface electrodes 704b and 706b (herein also referred to as central interface electrodes) is different to the shape and tapering of the additional interface electrodes (e.g. 704a, 706a). As shown in FIG. 7, the additional interface electrodes 704a and 706a begin at a point at which the two initial interface electrodes reduce in width. In other words, the interface electrodes are not tapered adjacent to the multipole and instead begin to taper within the interface. The additional interface electrodes 704a and 706a increase in width to the width of the RF electrodes, wherein the additional interface electrodes are wedge shaped such that their initial width is close to zero. In contrast, the central interface electrodes 704b and 706b are continuous with the initial two interface electrodes, such that each of the central interface electrodes 704b and 706b have an initial width equal to the width of the multipole electrodes, where the central interface electrodes are each adjacent to an initial interface electrode, in the z direction. The width of the central interface electrode 704b decreases such that the end of the interface electrode closest to the RF electrode has a width equal to the width of the adjacent RF electrode 709d which forms part of the RF surface. In other words, the width of the additional interface electrodes increases in correspondence with the width of the central interface electrodes decreasing, i.e. the change in width of the central interface electrodes is proportional to the change in width of the additional interface electrodes. As shown in FIG. 7, the central interface electrodes 704b and 706b have an inner edge which is not parallel to the edge which separates the initial interface electrodes 716a and 718a. In other words, the edge separating the two central inner electrodes is not parallel with the edge which separates the initial interface electrodes 716a and 718a. Therefore, the central multipole channel has a turn, wherein the central multipole channel may refer to the channel of electrodes formed by the initial two interface electrodes 716a and 718a, and the central interface electrodes 704b and 706b.

Although each of the first interface electrodes and central interface electrodes are illustrated as being continuous with the respective RF electrode, the interface electrodes may be formed separately from the RF electrodes. Alternatively, each interface electrode may be continuous with the respective RF electrode.

Although it has been described that the initial interface electrodes, i.e. the electrodes adjacent to the multipole, are not tapered. Instead, the interface may comprise electrodes whose width in the x direction starts decreasing adjacent to the multipole, i.e. the electrodes adjacent to the multipole may be tapered.

In one example, the multipole RF electrodes have a width of 8 mm, such that the width of the interface RF electrodes is initially 8 mm and decreases within the transition region.

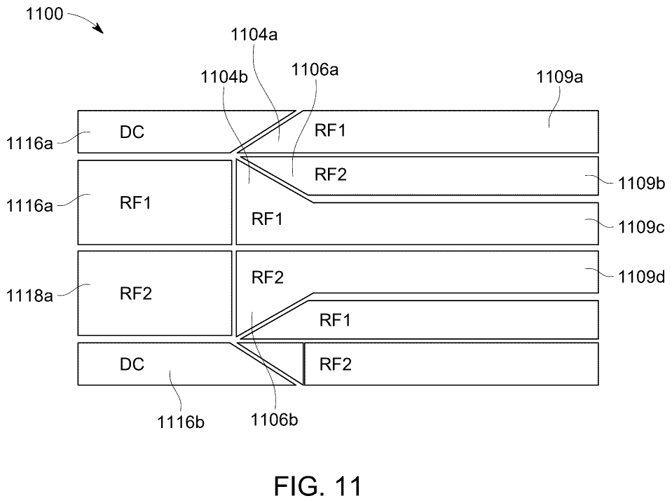

As shown in FIG. 7, the design of the ion guiding system 700 has the result that the direction of the central multipole channel is changed due to additional electrodes being created within the transition region, i.e. due to the inner edge of the tapered interface electrodes not being parallel to the initial interface electrodes, and therefore the multipole electrodes, and/or to the RF surface electrodes. This turn in the central multipole channel may have the disadvantageous effect of creating a pseudopotential barrier, even though such a barrier is small. Therefore, an alternative embodiment is provided which overcomes this problem and will be described in relation to FIG. 11.

It will be appreciated that the use of interface electrodes which are wedged in the x direction enables the interface electrodes to be formed in the same way as the RF electrodes. For example, the electrodes may be PCB printed, wherein the electrodes may be PCB printed from the same substrate as the RF electrodes.

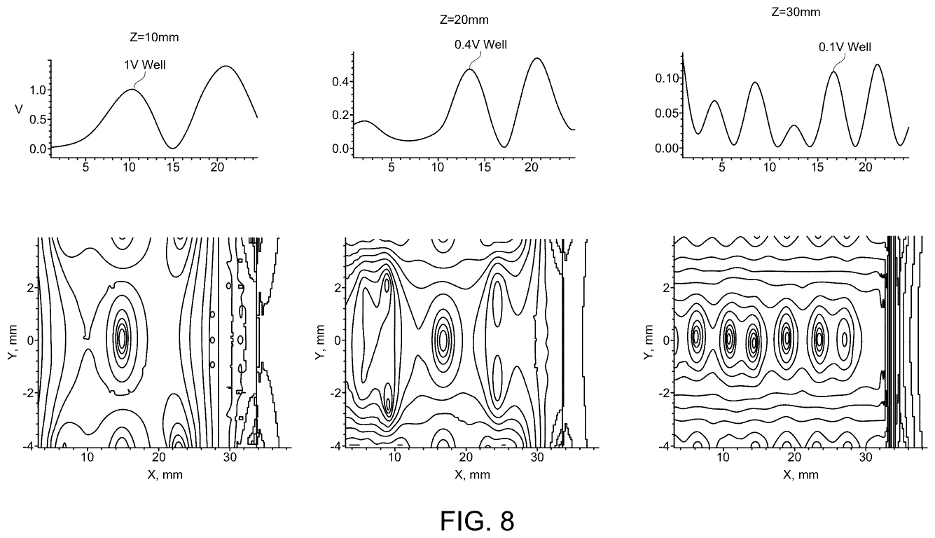

FIG. 8 shows a pseudopotential profile of the ion guiding system 700. In this example the multipole is a quadrupole. FIG. 8 shows the pseudopotential profile at z=10 mm, z=20 mm, and z=30 mm, wherein z=0 is the start of the interface region. The ion guiding system 700 has a height 10 mm in the y direction, and has a length 50 mm in the z direction, and has a width 40 mm in the x direction. As shown in FIG. 8, at z=10 mm, the profile has two peaks of around 1V and 1.5V, at around x=10 mm and x=20 mm respectively. At z=20 mm there are two peaks of around 0.4V and 0.5V, at around 13 mm and 21 mm respectively. At z=30 mm there are 5 peaks, where three of the peaks are around 0.1V, one peak is around 0.06V and the fifth peak is around 0.02V. These five peaks are substantially equally spaced from each other. Therefore, it can be seen from FIG. 8, the deep pseudopotential channel shown at z=10 mm is eroded.

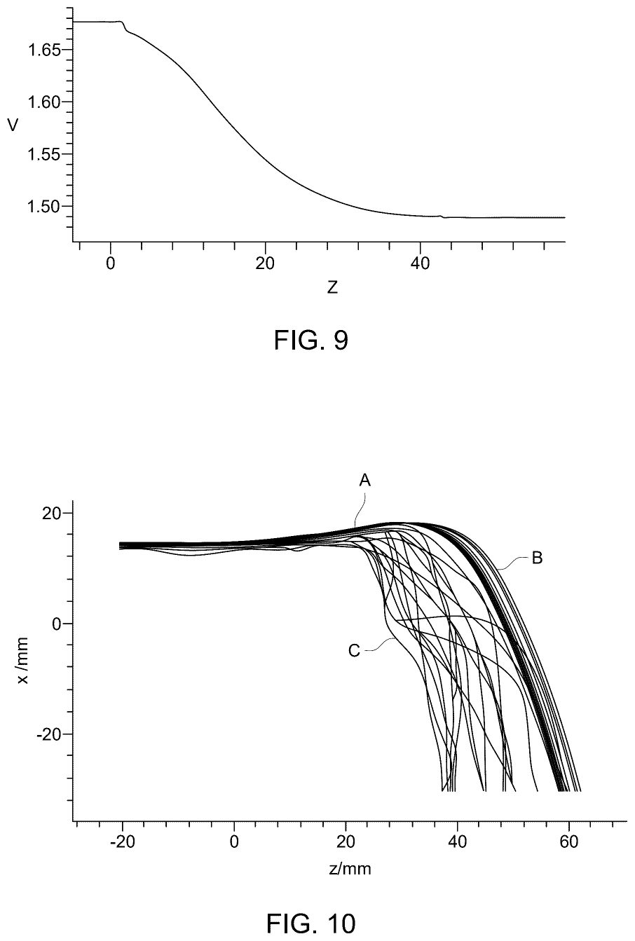

FIG. 9 shows the DC gradient generated by the 2V wedge shaped DC electrodes illustrated in FIG. 7. As shown in FIG. 9, at z=0 a DC voltage of around 1.67V is generated. The DC voltage decreases such that at around z=20 mm the DC voltage is around 1.55V, and at z=40 mm the DC voltage is around 1.5V. The DC voltage is substantially constant after z=40 mm, as the wedged DC electrodes do not extend past the transition region, i.e. the wedged DC electrodes do not extend into the RF surface. Therefore, the DC voltage is greatest when the DC electrodes have the greatest width, and the DC voltage decreases as the width of the DC electrodes decrease.

FIG. 10 shows a simulation of ion trajectories from a quadrupole ion guide to an RF surface at different energy and pressure conditions, wherein the ions have a mass to charge ratio (m/z) of 200. The graph shows the ion path at z=−20 mm, i.e. before the ions enter the interface, and are travelling through the multipole. As described in relation to FIG. 4, the ions enter the interface, and their direction changes due to a DC gradient. When the system was simulated as being arranged in a gas free environment, ions pass through the system with no issues, and the ions follow a trajectory shown by label B in FIG. 10. These ions pass through the system and each ion bends following approximately the same path, such that a smooth curve is formed on the graph shown in

FIG. 10. When the system is in an environment with nitrogen (N₂) being added at 0.01 mbar, it is shown that ions need a higher energy to be able to cross the interface. Ions having 1.0 e V in such an environment are shown by label A. It is shown that these ions cannot cross the interface and therefore are reflected backwards in the opposite direction to that in which they entered the system. Ions having 5.0 eV are shown by label

C in an environment with nitrogen added at 0.01 mbar. Such ions with higher energy can cross the interface and are shown to curve due to the DC gradient. The ions are shown to scatter due to the gas in the environment, and therefore the ions do not follow exactly the same path and may bend at different distances in the z direction.

Low energy ions cannot cross the interface due to a pseudopotential barrier being formed due to the quadrupole channel being turned within the interface, as described in relation to FIG. 7. Therefore, as illustrated in FIG. 10, ions need a higher energy to overcome this pseudopotential barrier. Therefore, it would be advantageous to provide an ion guiding system having similar features to system 700 which does not have a pseudopotential barrier created in the interface.

FIG. 11 illustrates an embodiment which does not create a pseudopotential barrier at the interface. The system 1100 of FIG. 11 has the same features as the system 700, in particular the system has wedge shaped interface electrodes which are wedge shaped in the x direction, and the system comprises two DC electrodes 1116a and 1116b, and additional interface electrodes are created within the transition region. Therefore, the number of electrodes increases within the transition region, such that the RF penetration is reduced, compared to the multipole. However, system 1100 differs from FIG. 11 in that the central multipole channel is not turned. The central multipole channel may refer to the channel of electrodes formed by the initial two interface electrodes 1116a and 1118a, and the central interface electrodes 1104b and 1106b. In other words, the inside edge of the multipole electrodes are in line with the inside edge of the inside RF surface electrodes. Therefore, the inner edge of the interface electrodes are in line with the inner edge of the multipole electrodes and RF surface electrodes. The interface electrodes which are located adjacent to the multipole electrodes 1116a and 1118a may be separate electrodes to the multipole electrodes. However, it will also be appreciated that the electrodes may be formed such that they are continuous with the multipole electrodes and/or RF electrodes. In the embodiment illustrated in FIG. 11, the interface electrodes are continuous with the respective RF electrodes.

To avoid a pseudopotential barrier being formed in the transition region, i.e. in the interface, the interface electrodes have a different configuration to those described in relation to FIG. 7. The central interface electrodes 1104b and 1106b, i.e. the interface electrodes which are located adjacent to the interface electrodes 1116a and 1118a (also referred to as initial interface electrodes), have a tapered portion (i.e. wedge shaped portion), wherein the tapered portion is positioned away from the centre of the interface.

In other words, the tapered portion does not overlap the central multipole channel. The central interface electrodes decrease in width in the x direction such that the initial total width of the interface electrodes is equal to the width of the multipole electrodes, and the total width of the interface electrodes decreases with an increased distance in the z direction from the multipole. In other words, the width of the central interface electrodes decreases, and the width of the additional interface electrodes increases in proportion to the decrease in width of the central interface electrodes. Due to the decrease in width of the central interface electrodes, a greater number of electrodes are present in the interface compared to the number of electrodes in the multipole.

The central interface electrodes 1104b and 1106b are separated by a straight edge which is parallel to the edge which separates the multipole electrodes 1116a and 1118a. In other words, the inner edge of the two central interface electrodes 1104b and 1106b is in line with, and parallel to, the inner edge which separates the multipole electrodes, such that the central multipole channel is not bent. In other words, the additional interface electrodes are formed such that the centreline of the central multipole channel is maintained. Therefore, a pseudopotential barrier is not formed at the interface.

It will be appreciated that although the ion guiding systems are described herein as separate embodiments with either interface electrodes wedge shaped in the x direction, or interface electrodes wedge shaped in the y direction, these embodiments could be combined. Therefore, an ion guiding system may comprise interface electrodes which extend in both the x and y directions to transition from a first field to a second. In other words, the embodiments of FIG. 3 and 2, 7 or 13 may be combined, wherein the same features and technical considerations apply as have been described in relation to each of these embodiments. The advantages of both embodiments would be combined to provide a transition between the multipole electrodes and RF surface electrodes.

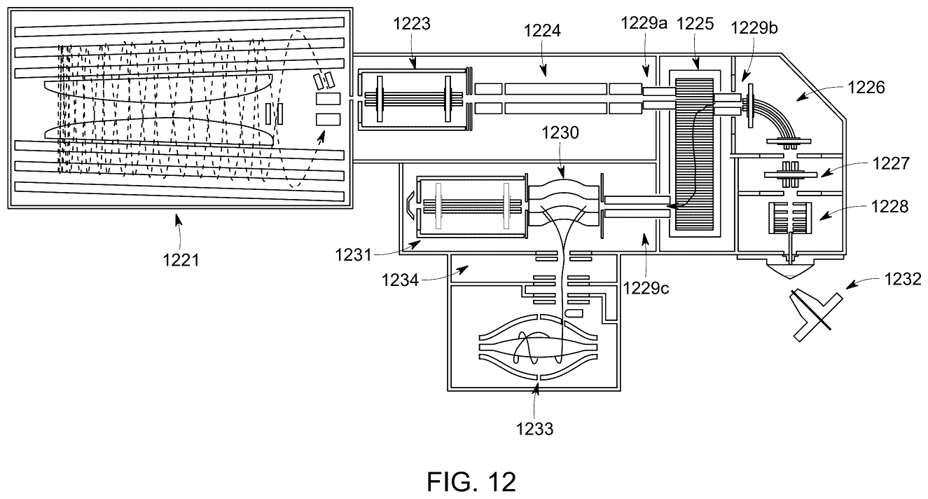

FIG. 12 illustrates an example of a use of the ion guiding system described herein. FIG. 12 illustrates an analytical instrument such as a mass spectrometer comprising a beam switching device. The beam switching device may comprise features of beam switching device 1250 described in GB2620377A, which is hereby incorporated by reference in its entirety. FIG. 12 of the present application shows a beam switching device which incorporates the disclosed technology for improved ion injection/extraction into and out of the beam switching device. The beam switching device comprises three quadrupole ion guiding systems 1229a, 1229b and 1229c, which may be any of the ion guiding systems described herein. The ion guiding systems are located in communication with the beam switching ion guide 1225, such that the ion guiding systems may be used for improved ion injection and/or extraction into and out of the beam switching ion guide. Therefore, the ion guiding systems provide an improved beam switching device. The beam switching device may be used to enable switching of an ion beam path between two analysers within the analytical instrument.

The instrument combines fast MS2 operation through a fast path to a multi-reflection time-of-flight (MR-ToF) analyser 1221 with a slow path to an Orbitrap™ mass analyser 1233 for MS1 optionally with ion processing within an adjacent ion trap 1231 (wherein MS1 may comprise analysis of unfragmented precursor ions, and MS2 may comprise analysis of fragmented precursor ions). The instrument may comprise an Electrospray ionization (ESI) source 1232, a lens 1228 (such as an S-lens comprising an ion funnel with increasing interpolate spacing between rings), an ion guide 1227 and a 90° ion guide 1226. The ion beam may then pass through a beam-switching ion guide 1225, which may be the beam switching ion guide of GB2209555.8, and the ion beam may be directed to the fast path or to the slow path. The fast path may comprise a quadrupole mass filter 1224, a collision cell 1223 and the MR-ToF analyser 1221. The slow path may comprise a C-trap 1230, a collision cell or ion trap 1231, one or more lenses 1234 and the Orbitrap™ mass analyser 1233. The ion guides 1227, 1226, guide the ion beam along a path. The beam switching device chooses between sending ions to the Orbitrap™ mass analyser, via the C-Trap 1230, or to the multi-reflection time-of-flight analyser 1221 via optional mass isolation and fragmentation. In the example of this instrument, the beam switcher is advantageous as otherwise the MR-ToF analyser must sit at the end of a long chain of ion optical components, with considerable time penalties and transmission losses. A split path also allows prolonged ion processing on the Orbitrap™ mass analyser side, for example MS3 operation within a resolving trap, without blocking parallel operation of the MR-ToF. Furthermore, the fast and slow paths may be arranged side by side to make the instrument more compact than a single long path.

An ion guiding system according to any of the embodiments described herein may be incorporated into an ion mobility separator and/or into an ion mobility spectrometer. Ion guides may be used for preparing and/or transferring samples in such instruments.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

The examples here show RF surfaces with a 1D array of elongated RF electrodes. It is also possible to separate the RF electrodes into a 2D array, so that each RF electrode is surrounded by electrodes of the opposite polarity.

The methods and apparatus of the present disclosure can be utilised with a variety of electrode structures. Electrodes of appropriate dimensions can be arranged into symmetrical or asymmetrical patterns upon substrates and if elongation of electrodes is beneficial for a particular application, the electrodes may be linear or curving. Individual electrodes can be planar, hemispherical, rectangular or of other shapes. The electrodes may be PCB printed electrodes.

Whilst the ion guiding system 200A, 200B, 300, 400, 600, 700, 1100 has been described as having a height (otherwise referred to as a depth) in a y-direction, a length in a z-direction and a width in an x-direction, it will be appreciated that the x-, y- and z-axes may be defined in other manners. For example, an ion guiding system that is rotated with respect to the ion guiding system 200A, 200B, 300, 400, 600, 700, 1100 shown in the drawings may be provided, without departing from the disclosure.

Furthermore, it will be appreciated that the x-, y- and z-axes are exemplary. For instance, the “height” of the ion guiding system may be along the x- or z-axis defined in the drawings. Likewise, the “width” of the ion guiding system (defined in the x direction herein) may be defined along the z-or y-axis and the “length” of the ion guiding system (distance between the multipole electrodes and RF surface electrodes) may be defined along the x- or y-axis.

Although FIGS. 2, 3, 4A, 4B, 6, 7, and 11 illustrate the plurality of electrodes extending in the z-direction, it will be appreciated that the electrodes could extend in other directions (for example, to change the direction of the guiding force applied by the RF electrodes.

It will be appreciated that there is an implied “about” prior to temperatures, concentrations, times, pressures, flow rates, cross-sectional areas, voltages, currents, etc. discussed in the present teachings, such that slight and insubstantial deviations are within the scope of the present teachings. Furthermore, values referred to as being “equal” may in fact differ by less than a threshold amount. The threshold amount may be 5%, for example. The threshold may also be greater than 5% (for example, 10%, 20% or 50%) or less than 5% (for example, 2% or 1%).

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an electrode) means “one or more” (for instance, one or more electrodes).

Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the invention. That is, an element termed a “first” element may instead be termed a “second” element) and an element termed a “second” element may instead be considered a “first” element.

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein.

Unless otherwise described, all technical and scientific terms used herein have a meaning as is commonly understood by one of ordinary skill in the art to which the various embodiments described herein belongs.

We claim:

1. An ion guiding system, comprising:
a multipole ion guide having a plurality of multipole electrodes configured to provide a first confinement field;
an RF confinement device configured to provide a second confinement field, wherein the RF confinement device comprises a radio frequency (RF) surface having a plurality of RF electrodes; and
an interface located in a transition region between the multipole ion guide and the RF surface, wherein the interface has a plurality of interface electrodes configured to provide an interface field that transitions between the first confinement field and the second confinement field.

2. An ion guiding system according to claim 1, wherein the interface is mounted on the same substrate as the RF surface.

3. An ion guiding system according to claim 1, wherein a distance, along a y-axis, between the plurality of RF electrodes and a plane around which ions are confined is greater than the distance, along the y-axis, between the plurality of multipole electrodes and the plane around which the ions are confined.

4. An ion guiding system according to claim 3, wherein the interface electrodes are shaped such that the distance, along the y-axis, between the surface of one or more or each of the interface electrodes and the plane around which the ions are confined decreases along the transition region.

5. An ion guiding system according to claim 4, wherein each of the interface electrodes has a surface which is oblique to both of the y axis and the z axis.

6. An ion guiding system according to claim 1, wherein a number of RF electrodes per unit length along an x axis is less than a number of multipole electrodes per unit length along the x axis.

7. An ion guiding system according to claim 1, wherein each interface electrode of the plurality of interface electrodes has a width, along an x axis, at a first end of the interface which is different to a width of the interface electrode at a second end of the interface.

8. An ion guiding system according to claim 1, wherein a number of interface electrodes per unit length along an x axis at a first end of the interface is different to a number of interface electrodes per unit length along the x axis at a second end of the interface.

9. An ion guiding system according to claim 1, wherein the interface electrodes comprises two central interface electrodes situated in the transition region, each having a width along an x axis that decreases along a y axis, and wherein additional interface electrodes within the transition region have a width, along the x axis, that increases in correspondence to the width of the central interface electrodes decreasing.

10. An ion guiding system according to claim 1, wherein the multipole ion guide defines a multipole channel which extends into the transition region, and wherein the interface electrodes are formed such that a centreline of the multipole channel is maintained.

11. An ion guiding system according to claim 10, wherein the plurality of RF electrodes comprises two central RF electrodes and wherein inner edges of the two central RF electrodes are configured to be aligned with inner edges of the multipole electrodes such that a centreline of the multipole channel is maintained.

12. An ion guiding system according to claim 1, wherein a DC gradient or DC travelling wave is applied to electrodes of the RF confinement device or wherein a gas flow is provided so as to force ions along an x axis.

13. An ion guiding system according to claim 1, comprising a first auxiliary DC electrode, configured to apply a force on ions such that they are directed towards the interface.

14. An ion guiding system according to claim 13, wherein the first auxiliary DC electrode has a surface which is oblique to the x-axis and the z-axis, such that ions forced along the x-axis by an applied DC gradient or DC travelling wave or a gas flow are forced along a z-axis, wherein the z axis is perpendicular to the x axis.

15. An ion guiding system according to claim 14, further comprising a second auxiliary DC electrode, wherein the first auxiliary DC electrode and the second auxiliary DC electrode are configured to provide a DC well in the x direction for extracting ions.

16. An ion guiding system according to claim 15, wherein the second auxiliary DC electrode is located at a second side of the interface electrodes, in the x direction, where the first auxiliary DC electrode is located at a first side of the interface electrodes, and/or wherein the second auxiliary DC electrode extends in the same plane as the first auxiliary DC electrode.

17. An ion guiding system according to claim 1, wherein the interface electrodes are set at a higher DC potential than the RF surface, such that a DC gradient is generated at the interface.

18. An ion guiding system according to claim 1, wherein one or more or each of the plurality of interface electrodes are segmented along a z axis to enable an additional DC gradient to be applied.

19. An ion guiding system according to claim 1, wherein the plurality of RF electrodes are formed along a substantially planar surface.

20. An ion guiding system according to claim 1, wherein the RF confinement device comprises a plate opposing a first RF surface, wherein a voltage is applied to the plate such that ions are repelled towards the RF surface, or wherein the RF confinement device further comprises a second RF surface opposing the first RF surface.

21. A beam switching device for an analytical instrument, comprising:
the ion guiding system of claim 1; and
a beam switching ion guide, wherein the ion guiding system is configured to inject and/or extract ions into and/or out of the beam switching ion guide.

22. A mass spectrometer comprising the ion guiding system of claim 1.

23. An ion mobility spectrometer comprising the ion guiding system claim 1.
